(19) United States
(12) Patent Application Publication
(10) Pub. No.: US 2026/0200697 A1
(43) Pub. Date: Jul. 16, 2026

(54) DOOR CONTROL UNIT FOR AN ELEVATOR SYSTEM, METHOD OF MAINTAINING AN ELEVATOR SYSTEM, AND MAINTENANCE DEVICE FOR MAINTAINING AN ELEVATOR SYSTEM

(71) Applicant: INVENTIO AG, Hergiswil (CH)

(72) Inventors: Luka Pivk, Kriens (CH); Dominik Sliwa, Horw (CH)

(21) Appl. No.: 19/138,186

(22) PCT Filed: Dec. 7, 2023
(86) PCT No.: PCT/EP2023/084760

§ 371 Date: Jun. 12, 2025

(30) Foreign Application Priority Data
Dec. 19, 2022 (EP) 22214489.1

(51) Int. Cl. B66B 1/34; B66B 5/00; B66B 13/14; B66B 13/22

(52) U.S. Cl. CPC B66B 1/3461; B66B 5/0087; B66B 13/146; B66B 13/22

(57) ABSTRACT

A door control unit for an elevator system includes a first communication module and a second communication module. The first communication module communicatively connects the door control unit with a data network of the elevator system. The door control unit is communicatively connectable, via the data network, with a car control unit of the elevator system. The second communication module is activated in response to a maintenance indicator signal. When activated, the second communication module operates as an access point of a wireless maintenance network wirelessly communicatively connecting the door control unit with a maintenance device via the wireless maintenance network.

### FIELD

The invention relates to a door control unit for an elevator system, a method of maintaining the elevator system and particularly a door control unit, and a maintenance device. Aspects of the invention particularly relate to establishing a communicative connection between a maintenance device and a door control unit of an elevator system for maintenance. Aspects of the invention particularly relate to reliably establishing a secure, wireless connection between the maintenance device and a door control unit requiring maintenance.

### BACKGROUND

Elevator systems are known in the art. Some elevator systems may be considered important or even critical infrastructure for the transport of passengers and/or goods. Accordingly, high levels of safety may need to be maintained, and unscheduled downtime may be undesirable.

Elevator systems typically include landing doors. The landing doors may be controlled and/or monitored by a door control unit. A faulty door control unit may result in the elevator system becoming inoperable until the fault has been resolved by a maintenance technician. Identifying and/or localizing the fault and, if required, repairing or replacing the faulty door control unit may be labor intensive and result in an extended downtime of the elevator system.

### SUMMARY

Thus, there is a need for efficiently maintaining a door control unit of an elevator system. The present disclosure may solve the problem, at least in part, according to aspects of the invention described below.

According to an aspect, a door control unit for an elevator system is described. The door control unit includes a first communication module. The first communication module is configured for communicatively connecting the door control unit with a data network of the elevator system. The door control unit is communicatively connectable, via the data network of the elevator system, with a car control unit of the elevator system. The door control unit includes a second communication module. The second communication module is configured for being activated in response to a maintenance indicator signal; when activated, being operated as an access point of a wireless maintenance network; and, when activated, wirelessly communicatively connecting the door control unit with a maintenance device via the wireless maintenance network.

According to an aspect, a method of maintaining an elevator system is described. The method includes communicatively connecting a door control unit with a data network of the elevator system by a first communication module of the door control unit, communicatively connecting the door control unit with a car control unit of the elevator system via the data network of the elevator system, generating a maintenance indicator signal, evaluating the maintenance indicator signal by the door control unit, and activating a second communication module of the door control unit. The second communication module is operated as an access point of a wireless maintenance network. The method further includes communicatively connecting the door control unit with a maintenance device via the second communication module.

According to an aspect, a maintenance device for maintaining an elevator system is described. The maintenance device includes an interface for communicating with the second communication module of a door control unit according to an aspect and/or embodiment described herein, and an authentication certificate, wherein the authentication certificate is configured for authenticating the maintenance device to the door control unit.

According to an aspect, a door control unit (DCU) is described. A DCU may be a device for controlling and/or monitoring a landing door of an elevator system. The DCU may include a control module and/or controller for controlling and/or monitoring an operation of a landing door of an elevator system. The DCU may control one or more motors and/or actuators for opening and closing the landing door. The DCU may control one or more locking mechanisms for controlling a locking and/or unlocking of the landing door. The DCU may further be communicatively connected to one or more sensors of the landing door. The sensors may include, but are not limited to, sensors for sensing a position and/or a locking state of the door, sensors for sensing the presence of persons or objects within the landing door such as light curtains or mechanical sensors for sensing a mechanical resistance when closing the door. The DCU may be configured for evaluating the sensor signals. During normal operation of the elevator system, the DCU may be communicatively connected to a controller of the elevator system, such as a car control unit (CCU). The DCU may receive control signals and, in response to the control signals, control the opening and closing of the landing doors associated with the DCU while maintaining a high level of safety. In the event of a fault or error, the DCU may be configured for providing a fault signal to a controller of the elevator system, e.g. for causing the elevator system to operate in a safety state and/or halting operation of the elevator system. The DCU may be communicatively connected to a landing operating panel (LOP). The LOP may be an interface of the elevator system, such as an input device for receiving inputs from a passenger, such as a panel having one or more buttons, keys, touchpads or the like for receiving an elevator call of a passenger. The DCU may be configured for communicating the input, e.g. a call signal, to a controller of the elevator system. According to embodiments, a DCU may be provided for each landing door of the elevator system, e.g. by being mounted to or in the vicinity of the landing door. According to further embodiments, e.g. in elevator systems having multiple landing doors on a single level, a DCU may be provided for the multiple landing doors.

According to an aspect, a car control unit (CCU) is described. The CCU may be a control module and/or controller for controlling and/or monitoring an operation of an elevator car in an elevator system. The CCU may be provided on or in the elevator car, e.g. by being mounted to or within the elevator car. The CCU may be communicatively connected to a car operating panel (COP). The COP may be an interface of the elevator system, such as an input device for receiving inputs from a passenger, such as a panel having one or more buttons, keys, touchpads or the like, e.g. for receiving a destination call of a passenger. The CCU may be configured for communicating the input, e.g. a call signal, to a controller of the elevator system. According to an aspect, the CCU may be configured for controlling and/or monitoring one or more functions of the elevator system, particularly functions related to the safety and/or operation of the elevator system and/or the elevator car.

According to an aspect, a data network of the elevator system is described. The data network may be a packet-based network. The data network may be an Ethernet network. The data network may use an Ethernet-based protocol, such as IEEE 802.3 as known at the time of filing of this disclosure. The data network may be based on an Industrial Ethernet standard, such as, but not limited to, EtherCAT, EtherNet/IP, PROFINET, POWERLINK, SERCOS III, CC-Link IE, Modbus TCP, or even FIELDBUS. The data network may be a separate network from other networks, such as a wide area networks, such as the internet. The data network may be secured, e.g. for preventing access to the data network from devices not associated with the elevator system.

According to an aspect, additionally, or alternatively, the data network of the elevator system may be a wireless network. According to an aspect, a wireless maintenance network is described. The wireless maintenance network is a wireless network. A wireless network may include and/or enable a communicative connection between at least two devices. Establishing and/or communicating via the wireless network may include transmitting radio signals between the at least two devices. The wireless network may be based on a protocol such as a wireless LAN (WLAN), such as a protocol based on an IEEE 802.11 standard as known at the time of filing this disclosure. The data network of the elevator system and the wireless maintenance network may utilize the same network protocol, or may utilize a different network protocol. Accordingly, the data network of the elevator system and the wireless maintenance network may be separate, or even incompatible networks.

### DESCRIPTION OF THE DRAWINGS

The details will be described in the following with reference to the figures, wherein:

FIG. 1 schematically shows a door control unit (DCU) according to an embodiment;

FIG. 2 schematically shows an elevator system according to an embodiment;

FIG. 3 shows a method of maintaining an elevator system according to an embodiment; and

FIG. 4 schematically shows a maintenance device according to an embodiment.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

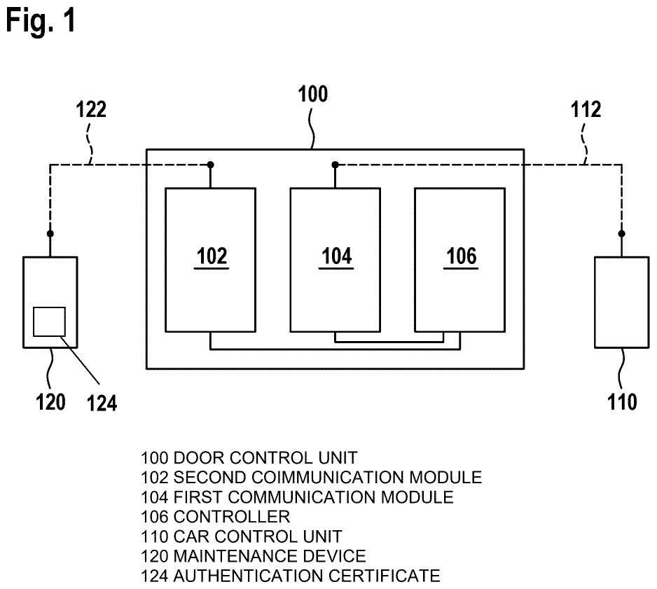

FIG. 1 shows a door control unit (DCU) 100 for an elevator system according to an embodiment. The DCU 100 has a first communication module 104 and a second communication module 102. In the example shown in FIG. 1, the first communication module 104 is communicatively connected to a data network 112, and via the data network 112, communicatively connected to a car control unit 110. In the example shown in FIG. 1, the second communication module 102 is activated and communicatively connected to a wireless maintenance network 122 and, via the wireless maintenance network 122, communicatively connected to a maintenance device 120. It should be noted that the communicative connections via the networks 112, 122, particularly the communicative connection between the DCU 100 and the maintenance device 120, may be transitory.

As shown in FIG. 1, the DCU 100 may include a controller 106. The controller 106 may be configured for performing tasks associated with the DCU, such as controlling and/or monitoring the operation of one or more landing doors. The controller 106 may include a processor and a memory. The memory may include a software. The software, when executed on the processor of the controller 106, may cause the controller to perform the tasks associated with the DCU 100. The software, when executed by the processor, may further cause the controller 106 to perform a method according to an embodiment described herein.

According to embodiments, the controller 106 may be configured for controlling an operation of the first communication module 104 and/or the second communication module 102. The first communication module 104 and the second communication module 102 may communicatively connect a device connected to the data network 112 and/or the wireless maintenance network 122 to the controller 106.

According to embodiments, the first communication module 104 and the second communication module 102 may be configured for connecting or being connected to a network. The network may be controlled, defined and/or established by the first communication module 104 and/or the second communication module 102. In particular, the first communication module 104 may be configured for connecting, as a client, to the data network 112. In particular, the second communication module 102 may be configured for establishing, e.g. as an access point, the wireless maintenance network 122. As shown in FIG. 1, the first communication module 104 and the second communication module 102 may be communicatively connected to the controller 106. The controller 106 may transmit, send, receive and/or broadcast data via the first communication module 104 and/or the second communication module 102. The data may be received from or receivable by a device communicatively connected to the network. Accordingly, the first communication device 104 and/or the second communication device 102 may enable the controller 106 to communicate with devices connected to the network that the first communication module 104 and/or the second communication module 102 are connected to. Furthermore, signals and/or data broadcast by the first communication module 104 and/or the second communication module 102 may be received by devices. For example, a maintenance device 120 may receive signals broadcast by the second communication module 102.

According to embodiments, the DCU 100 including the controller 106, and optionally even the first communication module 104 and/or the second communication module 102, may be implemented as and/or include a computer, such as e.g. a microcomputer, a single board computer, an embedded device, a system-on-a-chip device, or any other suitable hardware. Additionally, or alternatively, the first communication module 104 and/or the second communication module 102 may be (separate) hardware modules connected to a bus of the controller 106.

According to embodiments, e.g. as shown in FIG. 1, both the first communication module 104 and the second communication module 102 may be wireless network interfaces for communicating with a wireless network, e.g. according to aspects or embodiments described herein. Alternatively, the first communication module 104 may be a wire-based network interface, and the second communication module 102 may be a wireless network interface. The first communication module 104 and the second communication module 102 may be separate modules, e.g. be implemented as separate network controllers. Alternatively, particularly in cases where the data network 112 and the wireless maintenance network 122 are of the same or a compatible network type, e.g. a wireless network according to IEEE 802.11, the first communication module 104 and the second communication module 102 may be virtual interfaces implemented as a single hardware module, such as a single network controller.

According to embodiments, the second communication module 102 may be activatable. Activatable, in the context of this disclosure, may be understood as being switchable from a state with no operation, or limited operation, such as a state in which the second communication module is not operated as an access point and/or is not broadcasting an SSID (service set identifier), into a state in which the second communication module 102 is enabled to operate as an access point of the wireless maintenance network 122 and/or wirelessly communicatively connecting with a maintenance device 120. Accordingly, the second communication module 102 may be de-activatable. The activation and/or deactivation of the second communication module 102 may be controlled by the controller 106.

According to embodiments, the second communication module 102 is configured for operating, when activated, as an access point of the wireless maintenance network 122. Operating the second communication module 102 as an access point may include operating the second communication module 102 as an access point according to a standard such as IEEE 802.11, allowing devices such as the maintenance device 120 to communicatively connect to the DCU 100, and/or broadcasting a service set identifier (SSID).

According to embodiments, the DCU 100 is configured for activating the second communication module 102 in response to a maintenance indicator signal. The maintenance indicator signal may be any type of signal indicating that the DCU 100 should enter a maintenance mode. The maintenance indicator signal may be generated externally from the DCU 100 and communicated to the DCU 100, or the maintenance indicator signal may be generated internally by the DCU 100. The maintenance indicator signal may be available and/or evaluable by the DCU 100, e.g. by the controller 106. A maintenance indicator signal may be an external signal receivable by the DCU 100. For example, the maintenance indicator signal may be generated in response to an input, e.g. of a maintenance technician, at an interface of the elevator system, such as at a LOP, a COP, or a maintenance interface, in order to obtain access to a maintenance function of the DCU 100. For example, a maintenance technician may press one or more buttons or keys, enter a code, provide a key, provide a signal, such as a radio signal, or otherwise access and provide an input at a terminal or panel of the elevator system. The interface may generate the maintenance indicator signal in response to the input, and communicate the maintenance indicator signal, e.g. via the data network 112, to the DCU 100. The DCU 100 may evaluate the maintenance indicator signal and, in response to the maintenance indicator signal, activate the second communication module 102.

Additionally, or alternatively, according to embodiments, a maintenance indicator signal may be generated by a device of the elevator system, e.g. in response to a fault of the device, and be communicated to the DCU 100, e.g. via the data network 112.

According to embodiments, the DCU 100 may be configured for generating a maintenance indicator signal, particularly in response to a fault and/or an indication of a fault. The fault may be an internal fault of the DCU 100. An internal fault of the DCU 100 may be understood as a fault directly associated with the DCU 100, and can include faults of a system, module and/or sensor connected to the DCU 100. Accordingly, it should be noted that even a correctly operating DCU 100 may experience an internal fault, e.g. if the DCU 100 is incapable of operating and/or performing task as intended. Internal faults may include, but are not limited to, faults of the DCU 100, faults of systems, modules, and/or sensors connected to the DCU 100, and/or a fault preventing the DCU from controlling and/or monitoring components of the elevator system controlled and/or monitored by the DCU 100 as intended. For example, the DCU 100 may be configured for detecting if a landing door sensor, and/or landing door actuator controlled by the DCU 100 is faulty. For example, an internal fault of the DCU 100 may include data corruption of a memory of the DCU, such as a memory of the controller 106. An internal fault of the DCU 100 may include a faulty configuration of the DCU 100. An internal fault of the DCU 100 may include an error logged in a log file stored in a memory of the DCU 100. An internal fault of the DCU may include a hardware fault of the DCU 100.

According to embodiments, the fault may include a loss of a communicative connection between the DCU 100 and a component of the elevator system, such as a loss of the communicative connection with the data network 112 of the elevator system, a loss of the communicative connection with the CCU 110, and/or a loss of the communicative connection with an LOP. According to embodiments, the DCU 100 may be configured for detecting a loss of a communicative connection by continuously evaluating heartbeat signals sent from one or more components of the elevator system, e.g. via the data network 112. The DCU 100 may be configured for detecting a fault indicating a loss of communication by detecting that no heartbeat signals and/or unexpected heartbeat signals have been received by the DCU within a predefined time interval. The predefined time interval may, for example, be a time interval of 1 or more seconds, 2 or more seconds, 5 or more seconds, or 10 or more seconds.

According to embodiments, the DCU 100 may be configured for deactivating the second communication module 102 in the absence of a maintenance indicator signal, and activating the second communication module 102 in response to a maintenance indicator signal. Additionally, or alternatively, in response to a maintenance indicator signal, the DCU 100 may be configured for keeping the second communication module 102 activated, e.g. indefinitely, or for a predetermined duration, and/or until the activation is reset, e.g. by a maintenance technician. This may beneficially allow a maintenance technician to identify and/or access a DCU 100 experiencing intermittent or transitory faults, even if the fault is not currently present.

According to embodiments, the DCU 100 may be configured for activating the second communication module 102 as an access point with a service set identifier (SSID). The SSID may be broadcast by the second communication module 102, e.g. to be received and displayed by the maintenance device 120. The SSID may include information for allowing a maintenance technician to identify the DCU 100. For example, the SSID may include symbols or even strings indicating that the access point is an access point of the DCU 100. For example, the SSID may include a type indicator indicating the type, model, generation and/or version of the DCU 100. Furthermore, additionally or alternatively, the SSID may include additional information, such as information indicative of a location of the DCU 100, such as the floor and/or landing of the DCU 100, or a designator, such as a number, assigned to the DCU 100.

According to embodiments, particularly in embodiments where the second communication module 102 is not operated as an access point in the deactivated state, operating the access point with an SSID and broadcasting the SSID may be understood as the SSID broadcast being a fault indicator. In other words, since the DCU 100 operates the second communication module 102 in response to a maintenance indicator signal, an SSID being broadcast by the DCU 100, particularly without having previously generated a maintenance indicator signal by an input at an interface of the elevator system, may indicate a fault.

According to embodiments, additionally or alternatively, the SSID may include, as a fault indicator, a fault description. For example, the SSID may include symbols and/or even strings representing fault or error codes, descriptors of the cause of the maintenance indicator signal, and/or other types of status information.

Beneficially, an SSID of the DCU 100 may be broadcast and received by a maintenance device 120. The maintenance device 120 may display the SSID, which may, for example and not limited thereto, read a string such as “error_sensor1_DCU_level2”. Beneficially, a maintenance technician having read the SSID may be informed e.g. of the type of error, the faulty component, and/or the location of the faulty DCU.

According to embodiments, the DCU 100 may be configured, upon establishing a wireless communicative connection between the DCU 100 and the maintenance device 120, to allow a user of the maintenance device 120 to access a service functionality of the DCU 100. For example, the DCU 100 may present status information, maintenance functionality, allow the installation of updated firmware, and/or offer other known service functionality known in the art. For example, and not limited thereto, the DCU 100, particularly the controller 106, may be configured for executing a web server software, such as a HTTP server, and a user of the maintenance device 120 may, after communicatively connecting to the DCU 100 via the wireless maintenance network 122, access a web page offering the service functionality on the maintenance device 120. Likewise, the DCU may be configured for offering the maintenance functionality to a dedicated maintenance software, such as a program or an app, being run on the maintenance device.

According to embodiments, the DCU 100 is configured for authenticating the maintenance device 120, particularly before connecting to the wireless maintenance network 122. Authentication may optionally include requiring the user of the maintenance device 120 to enter a password and/or user credentials, e.g. as is known in the art for Wi-Fi Protected Access (WPA), WPA2, WPA3, or WPA2-PSK.

According to embodiments, authenticating the maintenance device 120 may, additionally or alternatively to requiring a password, include a certificate-based authentication of the maintenance device 120. The DCU 100 may include an authentication server. The DCU 100, particularly the controller 106, may be configured for executing an authentication server software. The authentication server may be configured for verifying an authentication certificate of the maintenance device. The authentication server may further be configured for verifying an authorization of the maintenance device 120.

The authentication server may be configured for authenticating the maintenance device according to a known certificate-based authentication method known in the art. Accordingly, the authentication server may be a server known in the art. For example, but not limited thereto, the authentication server may be a server utilizing RADIUS-based authentication, as known at the date of filing this application, where RADIUS is Remote Authentication Dial-In User Service networking protocol. It should be noted that an authentication server, in the context of this disclosure, should be understood as a software suitable for verifying a certificate of the maintenance device 120. Some RADIUS-based solutions may employ an architecture in which this may include operating the DCU as a RADIUS client. Accordingly, the DCU 100 may be configured as a RADIUS client, and/or a RADIUS server. Suitable known RADIUS solutions include, but are not limited to, FreeRADIUS and hostapd.

The DCU 100 may have stored, e.g. in a memory of the controller 106, a server certificate. The server certificate may be signed by a root certificate, such as a certificate issued by a root certificate authority, or a certificate derived, e.g. in a chain of trust, from a certificate signed by a root certificate authority. The root certificate authority may, for example, be a manufacturer of the DCU 100, and/or a manufacturer, installer and/or owner of the elevator system. The DCU 100 may be configured for receiving a server certificate, such as an updated server certificate, via a public key infrastructure (PKI).

The maintenance device 120 may have stored, e.g. in a memory of the maintenance device 120, an authentication certificate 124. The authentication certificate 124 may be derived from, e.g. signed with, a certificate derived from the root certificate, such as the server certificate or the root certificate. Accordingly, the DCU 100 may be configured for authenticating the maintenance device 120, when connecting to the wireless maintenance network 122, based on the server certificate and the authentication certificate 124.

According to embodiments, the DCU 100 may be configured for authorizing the maintenance device 120. Authorization, in the context of this disclosure, may be understood as any utilization of a user and/or device policy. In a first example, a maintenance device 120 may be fully authorized as a result of being authenticated. In a second example, the DCU 100 may be configured for applying specific policies. The DCU 100 may have stored, e.g. in a memory of the controller 106, a list, or and other type of data structure, of user, group and/or device credentials and policies associated with the credentials. For example, the list may define policies assigning predefined permissions to a selection of maintenance devices 120. For example, a first maintenance device 120 may have read-only permissions, e.g. to review status information of the DCU 100, while a second maintenance device 120 may have read-write-permissions, e.g. to change a configuration of the DCU 100.

According to embodiments, the server certificate and/or the list of credentials may be modifiable, e.g. by communicatively connecting the DCU 100 to an external device, such as a server configured for updating the DCU 100. For example, according to embodiments, the DCU 100 may be configured for connecting, e.g. via the data network 112 and an edge device providing a communicative connection between the data network 112 and a wide area network, such as the internet, to the external device, and receiving an update from the external device. An update may include one or more server certificates and or policies to be installed and/or replaced on the DCU 100, such as in a memory of the controller 106.

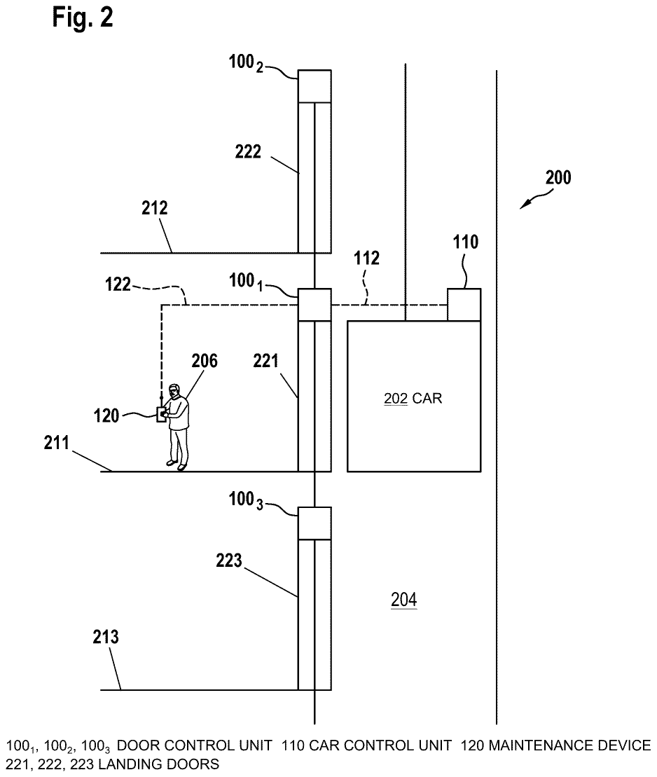

Referring now to FIG. 2, an elevator system 200 according to embodiments is described. The elevator system 200 includes an elevator car 202 movably provided within an elevator shaft 204. The elevator system 200 may be an elevator system for transporting passengers.

As shown in FIG. 2, the elevator car 202 includes a CCU 110. The CCU 110 may be communicatively connected to a CCP (not shown) provided within the elevator car. The CCU 110 may include a controller. The controller may include a processor and a memory. The memory may include a software. The software, when executed by the processor of the controller, may cause the controller to perform tasks associated with the CCU 110. The software, when executed by the processor, may further cause the controller to perform a method according to an embodiment described herein. The CCU 110 may include a communication module for communicatively connecting the CCU to the data network 112.

The elevator system 200 includes three landings 211, 212 and 213, each being provided with landing doors 221, 222 and 223 respectively. The landing doors 221, 222, 223 are operated and/or monitored by DCUs 100₁, 100₂, 100₃ respectively. Each of the DCUs 100₁, 100₂, 100₃ (collectively DCUs 100) may be a DCU 100, as described herein with reference to FIG. 1. In the exemplary embodiment shown in FIG. 2, the DCU 100₁ is communicatively connected to the CCU 110 via the data network 112, and further communicatively connected to a maintenance device 120 via the wireless maintenance network 122. Accordingly, in the shown example, the second communication module 102 of the DCU 100₁ is activated.

According to embodiments, more than one, or even all of the DCUs 100 may be communicatively connected to the data network 112, and/or be communicatively connected to the CCU 110 via the data network 112. For example, each DCU 100 may be communicatively connected to a wireless access point of the data network 112. The CCU 110 may include the access point of the data network 112. Furthermore, according to embodiments, the DCUs 100 may be configured to be operated in a mesh network, e.g. as clients within a mesh network. The mesh network may be the data network 112, or communicatively connect to the data network 112. Beneficially, this may allow the DCUs 100 to remain communicatively connected to the CCU 110 despite being out of range for a direct communication with the CCU 110.

FIG. 2 shows a maintenance technician 206 holding a maintenance device 120. The maintenance device is communicatively connected to the DCU 100₁. The maintenance technician may access maintenance functions of the DCU 100₁ by means of the maintenance device 120.

As shown in FIG. 2, in the given example, of the DCUs 100, only the DCU 100₁ is operating as an access point for the wireless maintenance network 122. According to embodiments, more than one, or even all of the DCUs 100 may operate as an access point for a wireless maintenance network, such as the wireless maintenance network 122. Each DCU 100 may provide an independent wireless maintenance network. Accordingly, each DCU 100 may broadcast, when activated, a unique SSID.

According to embodiments, more than one DCU 100, or even all of the DCUs 100 may operate as an access point for a wireless maintenance network simultaneously. As discussed with reference to FIG. 1, the DCUs 100 are configured for activating the second communication module 102 in response to a maintenance indicator signal. Accordingly, independent maintenance indicator signals may be provided to or generated by the DCUs 100. Additionally, or alternatively, a maintenance indicator signal generated by an input at an interface of the elevator system may activate one DCU 100, several selected DCUs 100, or even all of the DCUs 100 of the elevator system 200. For example, an input provided at an LOP or a COP, e.g. by a maintenance technician, may cause all the DCUs to operate as an access point for a wireless maintenance network. This may beneficially allow a maintenance technician to quickly perform some tasks, such as connecting to each DCU 100 to perform maintenance.

According to embodiments, the second communication modules 102 of the DCUs 100 may, during normal operation, be deactivated, i.e. not operate as an access point of a wireless maintenance network. This may beneficially reduce RF congestion.

According to embodiment, the DCUs 100 may, e.g. following an input by a maintenance technician to generate a maintenance indicator signal, or even during normal operation, each simultaneously operate as an access point. This may, however, in some cases result in several SSIDs being broadcast, and may even result in RF congestion. Selecting the desired wireless maintenance network, e.g. of a faulty DCU 100, may thus be difficult. Accordingly, a priority indicator signal may be generated, e.g. by a DCU experiencing a fault, by the CCU 110 e.g. in response to an input, or by any other component of the elevator system 200. The priority indicator signal may be targeted towards selected DCUs 100, or even be broadcast. The priority indicator signal may be communicated e.g. via the data network 112. In response to the priority indicator signal, the DCUs 100 receiving the priority indicator signal may be configured for deactivating the second communication module 102. This may beneficially simplify selecting the desired DCU 100, such as a DCU having lost connection to the data network 112.

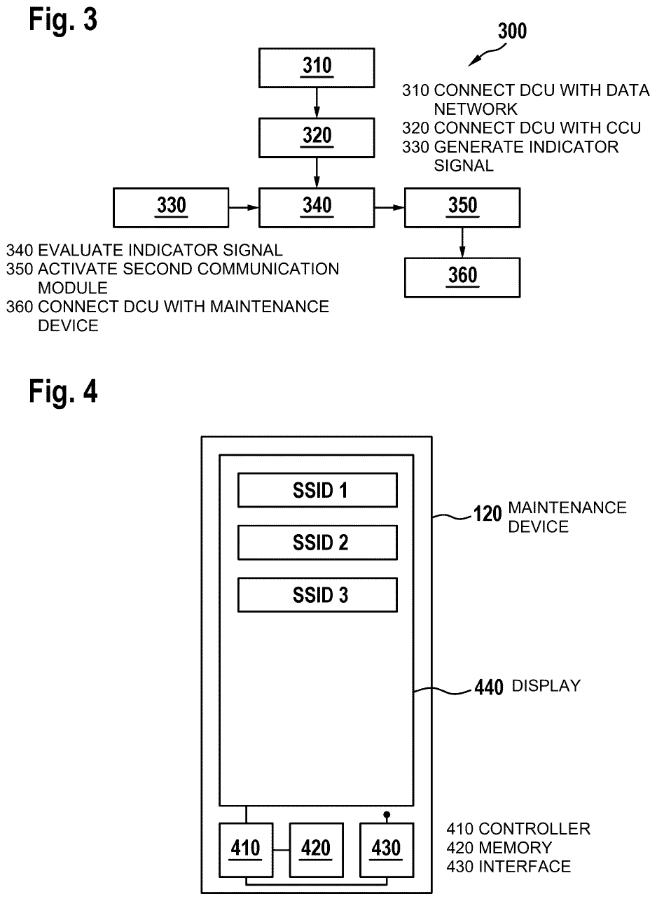

Referring now to FIG. 3, a method 300 of maintaining an elevator system is described. The elevator system may be an elevator system 200 as described with reference to FIG. 2. The method 300 may be a method of maintaining a DCU 100 of an elevator system, such as a DCU 100 described with reference to FIGS. 1 and/or 2. According to embodiments, the DCU 100, particularly the controller 106, may be configured for performing operations of the method 300 attributed to the DCU. Likewise, the maintenance device 120 described with reference to FIG. 4, particularly the controller 410, may be configured for performing operations of the method 300 attributed to the maintenance device 120.

The method 300 includes communicatively connecting in step 310 a DCU with a data network 112 of the elevator system by a first communication module 104 of the door control unit. The method 300 may include maintaining the communicative connection to the data network, e.g. during normal operation of the elevator system.

The method 300 includes communicatively connecting in step 320 the DCU with a CCU 110 of the elevator system via the data network of the elevator system. Accordingly, the method 300 may include communicatively connecting the CCU to the data network. The method 300 may include maintaining the communicative connection between the DCU and the CCU, e.g. during normal operation of the elevator system. The method may include sending heartbeat signals between the DCU and the CCU, such as regularly sending heartbeat signals from the CCU to the DCU.

The method 300 includes generating in step 330 a maintenance indicator signal. The maintenance indicator signal may be generated as described with reference to FIG. 1 or FIG. 2. For example, the maintenance indicator signal may be generated following an external input, and/or the maintenance indicator signal may be generated in response to a fault. A fault may be, for example, an internal fault of the DCU, and/or a loss of a communicative connection of the DCU to the data network, the CCU and/or an LOP. Accordingly, since the loss of a communicative connection between the DCU and the data network and/or the CCU may be indicative of a fault, maintaining a communicative connection to the data network and/or the CCU is not essential for performing the method 300.

The method 300 includes evaluating in step 340 the maintenance indicator signal. The maintenance indicator signal may be evaluated by the DCU. Evaluating 340 the maintenance indicator signal may include determining the origin of the maintenance indicator signal. Evaluating the maintenance indicator signal may include determining if a maintenance indicator signal is present. Furthermore, evaluating the maintenance indicator signal may include further processing and/or evaluation of the maintenance indicator signal. For example, the maintenance indicator signal may be provided with, include, and/or indicate a fault description, and information may be derived from the fault description. For example, a maintenance indicator signal may be provided from an external signal source, and information about the maintenance indicator signal may be derived from the source of the maintenance indicator signal. For example, a DCU may derive that a maintenance indicator signal received from an LOP or a COP following an input of a maintenance technician indicates a scheduled maintenance. For example, a loss of communication may result in a fault indicator indicating the loss of communication. Further fault indicators may include hardware faults, configuration faults, power outages, intrusion detection, or the like. The fault description may be included, as a fault indicator, in an SSID broadcast by the DCU.

The method 300 includes activating in step 350 a second communication module 102 of the DCU. The second communication module may be activated in response to evaluating and/or having evaluated the maintenance indicator signal. The second communication module is operated as an access point of a wireless maintenance network 122. The wireless maintenance network may be a wireless network according to IEEE 802.11, such as IEEE 802.11b/g/a/n/ac/ax/ad, however, alternative protocols may be utilized. Operating the second communication module as an access point may include broadcasting an SSID of the wireless maintenance network. The SSID may be receivable by devices such as a maintenance device 120. A user of the maintenance device may be presented with a list of available wireless networks, and the list of available wireless networks may include the SSID of the wireless maintenance network.

The method 300 includes communicatively connecting in step 360 the DCU with the maintenance device via the second communication module. Communicatively connecting the DCU with the maintenance device may include connecting the maintenance device to the wireless maintenance network established by the DCU. Furthermore, communicatively connecting the DCU with the maintenance device may include establishing a bidirectional data connection, particularly a communication in which the maintenance device may transmit data to and receive data from the DCU.

According to embodiments, the method 300, particularly after activating 350 the second communication module, may include authenticating the maintenance device. In some embodiments, authenticating the maintenance device may include connecting the maintenance device to the wireless maintenance network and/or logging the maintenance device into the wireless maintenance network. Authenticating the maintenance device may optionally include a password-and/or credential-based authentication. Authenticating the maintenance device may particularly include verifying an authentication certificate 124 of the maintenance device 120.

According to embodiments, the method 300, particularly during or after authenticating the maintenance device, may include determining an authorization of the maintenance device. Determining the authorization may include determining permission, policies, access rights, and/or other information associated with granting rights, associated with a maintenance device. Determining the authorization of the maintenance device may include selecting, based on the authorization, a subset of functions available to the maintenance device and/or a user of the maintenance device. Accordingly, a fully authorized maintenance device may have access to some or even all maintenance functions, while an unauthorized or only partially authorized maintenance device may have limited access.

According to embodiments, the method 300 may include, after communicatively connecting the DCU with the maintenance device, and particularly after authenticating and/or authorizing the maintenance device by the DCU, accessing a maintenance functionality of the DCU with the maintenance device. In particular, a maintenance technician may utilize the maintenance device as an interface for accessing the maintenance functionality.

According to embodiments, the method 300 may be performed for one or more DCUs within an elevator system. The method may include providing the elevator system and/or fitting an elevator system with one or more DCUs configured for performing functions according to embodiments described herein.

According to embodiments, the maintenance device 120 may be a transitory device, such as a mobile device provided by a maintenance technician when servicing the elevator system. Accordingly, the method 300 may include providing the maintenance device, and/or bringing the maintenance device into proximity of the DCU, e.g. until the maintenance device and the DCU are within radio signal range for communicating within the wireless maintenance network.

According to embodiments, the maintenance device may be definable by being authenticatable and/or authorizable by the elevator system, particularly the DCU. Accordingly, the method 300 may include installing an authentication certificate for authenticating the maintenance device to the DCU on the maintenance device. Installing the authentication certificate may optionally include further configuring the maintenance device for communicatively connecting the maintenance to the DCU and/or performing maintenance, such as installing further software, such as a maintenance software, program and/or app.

According to embodiments, installing the authentication certificate on the maintenance device may include accessing the DCU, e.g. by an authenticatable device, and causing the DCU to generate and/or copy an authentication certificate to a previously non-authenticatable device. For example, a first maintenance technician may connect to the DCU with an authenticatable first maintenance device according to embodiments described herein, and initiate a handover function on the DCU. The handover function may include communicating an authentication certificate to a previously non-authenticatable second maintenance device. After receiving the authentication certificate, the second maintenance device may be authenticable, and may connect to the DCU according to embodiments described herein.

According to embodiments, an authorization certificate may be revocable. For example, an authorization certificate may be set to expire at a predefined date. For example, the DCU may be configured, e.g. automatically or in response to an input, for revoking selected authentication certificates. Furthermore, the DCU may be configured for dynamically adjusting policies, such as access privileges, for selected maintenance devices and/or the authentication certificates associated with the maintenance devices. This may beneficially allow selected maintenance devices to be excluded from accessing a DCU, without requiring access to the maintenance device to be excluded, e.g. in case of a potential security breach e.g. due to loss of the maintenance device, or the expiration of a maintenance contract.

According to embodiments, the method 300 may include verifying, by the maintenance device, that the DCU is a trusted DCU. This may include verifying that the authentication certificate installed on the maintenance device is within the same chain of trust as a server certificate stored on the DCU. This may beneficially prevent the maintenance device from connecting to untrusted DCUs and/or systems emulating a DCU, which may improve security.

Referring now to FIG. 4, a maintenance device 120 for maintaining an elevator system 200 according to embodiments is described. The maintenance device 120 includes a controller 410, a memory 420, an interface 430 and a display 440. The maintenance device 120 may be a portable device. For example, and not limited thereto, the maintenance device 120 may be a smartphone, a portable computer such as a laptop computer, a tablet, and/or a wearable device such as a smartwatch.

The interface 430 may be a communication module configured for communicating with the second communication module 102 described with reference to FIG. 1. For example, the interface 430 may be a Wi-Fi adapter, such as a Wi-Fi adapter of a smartphone.

The controller 410 may include a processor. The processor may be configured for executing software, such as one more software programs, to cause the mobile device to connect to a second communication module of a DCU 100 according to embodiments described herein. The software programs may be stored in the memory 420. The memory 420 is communicatively connected to the controller 410, and may be accessible by the controller. The memory 420 includes, particularly having stored thereon, an authentication certificate. The authentication certificate may be configured for authenticating the maintenance device to a DCU according to embodiments described herein. In particular, the controller 410 may access the certificate and, based on the certificate, process information, such as information exchanged during a handshake, for authenticating the mobile device to the DCU.

The mobile device includes a display 440. In the example shown in FIG. 4, the controller 410 controls the display 440 to display a list of available wireless networks. In the example, the SSIDs of the networks, SSID 1, SSID 2 and SSID 3 are displayed. A maintenance technician operating the maintenance device 120 may select one of the displayed SSIDs, e.g. based on the information included in the SSIDs.

In an exemplary scenario, SSID 1 may read “Home WiFi”, SSID 2 may read “Office Printer”, and SSID 3 may read “error_sensor1_DCU_level2”. Accordingly, the maintenance technician may easily determine, from the displayed SSID, that only SSID 3 is relevant to the maintenance of the elevator system. Furthermore, the maintenance technician may determine that the DCU of level 2 has activated a second communication module due to a maintenance indicator signal caused by a fault in the component “sensor1”. The service technician may now easily determine the location of the DCU experiencing the fault. Furthermore, the service technician may connect to the wireless maintenance network, and perform maintenance on the elevator system, particularly the DCU, without physically accessing the DCU.

Beneficially, embodiments described herein may simplify maintenance of an elevator system by allowing a maintenance technician to easily identify and locate faults. Furthermore, a certificate-based authentication system according to embodiments may offer higher security than a purely password-based system. Certificates may be revocable, which may allow a secure management of authenticatable maintenance devices. Accessing a DCU with a maintenance device, according to embodiments described herein, may allow maintaining or repairing the DCU, without requiring physical access or even replacing the DCU.

While the foregoing is directed to some embodiments, other and further embodiments may be devised without departing from the basic scope, and the scope is determined by the claims that follow.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A door control unit for an elevator system, the door control unit comprising:
a first communication module communicatively connecting the door control unit with a data network of the elevator system, and wherein the door control unit communicatively connects via the data network with a car control unit of the elevator system;
a second communication module being activated in response to a maintenance indicator signal to operate as an access point of a wireless maintenance network; and
the second communication module, when activated, wirelessly communicatively connects the door control unit with a maintenance device via the wireless maintenance network.

17. The door control unit according to claim 16 wherein the data network of the elevator system is a wireless network.

18. The door control unit according to claim 16 wherein the access point has an associated service set identifier, including a fault indicator, and the second communication module broadcasts the service set identifier on the wireless maintenance network.

19. The door control unit according to claim 16 wherein the wireless maintenance network is separate from the data network of the elevator system.

20. The door control unit according to claim 16 wherein the door control unit authenticates the maintenance device.

21. The door control unit according to claim 20 wherein the door control unit is adapted to operate as an authentication server, and wherein the authentication server verifies an authentication certificate of the maintenance device as an authorization of the maintenance device.

22. An elevator system comprising:
an elevator shaft;
an elevator car movable in the elevator shaft;
a data network;
a car control unit connected to the data network and controlling movement of the elevator car;
a landing door providing access to the elevator car from a landing; and
the door control unit according to claim 16 communicatively connected to the car control unit via the data network.

23. A method of maintaining an elevator system, the method comprising steps of:
providing the door control unit according to claim 16;
communicatively connecting the door control unit with a data network of the elevator system by the first communication module of the door control unit;
communicatively connecting the door control unit with a car control unit of the elevator system via a data network of the elevator system;
generating a maintenance indicator signal to the door control unit;
evaluating the maintenance indicator signal by the door control unit;
activating the second communication module of the door control unit in response to the evaluation of the maintenance indicator signal to operate as an access point of a wireless maintenance network; and
communicatively connecting the door control unit with a maintenance device via the second communication module and the wireless maintenance network.

24. The method according to claim 23 wherein the activating the second communication module includes transmitting a service set identifier, including a fault indicator, from the second communication module to the maintenance device.

25. The method according to claim 23 wherein the communicatively connecting the door control unit with the maintenance device includes authenticating the maintenance device by the door control unit.

26. The method according to claim 25 wherein the authenticating the maintenance device includes:
verifying, by the door control unit, an authentication certificate of the maintenance device; and
determining, by the door control unit, an authorization of the maintenance device based upon verification of the authentication certificate.

27. The method according to claim 23 wherein the maintenance indicator signal is generated in response to a fault occurring in the elevator system, and wherein the fault is at least one of:
an internal fault of the door control unit;
a loss of the communicative connection of the door control unit with the data network of the elevator system;
a loss of the communicative connection of the door control unit with the car control unit; and
a loss of a communicative connection of the door control unit with a landing operating panel of the elevator system.

28. The method according to claim 23 wherein the maintenance indicator signal is generated by an input at an interface of the elevator system.

29. The method according to claim 23 including installing on the maintenance device an authentication certificate for authenticating the maintenance device to the door control unit.

30. A maintenance device for maintaining an elevator system, the maintenance device comprising:
an interface adapted to communicate with the second communication module of the door control unit according to claim 16; and
an authentication certificate adapted for use by the door control unit to authenticate the maintenance device.
